(19) United States
(12) Patent Application Publication
(10) Pub. No.: US 2002/0178058 A1
(43) Pub. Date: Nov. 28, 2002

(54) Method of communicating over an interactive medium

(76) Inventors: Arlen Ritchie, Toronto (CA); Grant Ritchie, Toronto (CA); Jason White, Toronto (CA)

Correspondence Address: HOFFMANN & BARON, LLP, 6900 JERICHO TURNPIKE, SYOSSET, NY, 11791, US

(21) Appl. No.: 10/100,862

(22) Filed: Mar. 19, 2002

(30) Foreign Application Priority Data
Mar. 22, 2001 (CA) 2,341,813

(51) Int. Cl. G06F 17/60

(52) U.S. Cl. 705/14

(57) ABSTRACT

The invention relates to a method of interfacing with one or more users over an interactive medium such as the internet. The method includes the steps of providing access to content of sufficient interest to said users to encourage said users to be receptive to specific information and then, providing such specific information to the users as a first precondition to permitting the users access to the content. Next, the users are required to provide a specific response relating to said specific information as a second precondition to access to said content. Lastly, upon said users meeting said first and second preconditions, the users are permitted to access said content. In a further aspect, user are able to accumulate rewards by responding appropriately to specific information and to then use those rewards towards a game, here they may accumulate additional rewards.

### FIELD OF THE INVENTION

This invention relates generally to the field of communication and more particularly to methods to help confirm that specific communications to individuals or groups have been successful. Most particularly this invention relates communications provided over an interactive medium such as the Internet.

### BACKGROUND OF THE INVENTION

Advertising has been known and used extensively in the past to promote the wares and services of businesses seeking to sell their products and services. Typically advertising is geared to the medium through which the advertising is placed. In one form of advertising, information is provided about a specific product or service in an effort to induce a prospective purchaser to purchase those specific goods or services due to their inherent features and benefits. In other forms of advertising rather than providing specific information about the products or services, a connection is made with a specific type of image or feeling, so the prospective purchaser will be persuaded to select the promoted wares and services to recapture the feeling.

Examples of different forms of advertising include print advertising used in magazines, newspapers and the like, and television and radio advertising, which is provided as a part of or complementary to television and radio programming. A difficulty in such traditional advertising is to direct the advertisements at people who are likely to purchase the products or services, namely, the ideal target market. For example, some forms of media, such as newspapers, are of general appeal. Thus advertising placed in such a publication has a broad reach, but is not very focused on any given target market. Television shows are sometimes able to attract a specific audience, but advertisements placed on television are commonly avoided by viewers through the use of remote control muting and channel surfing. As a result not only is the supplier of goods and services not sure who has received the promotional message, but they are also not sure of whether the message has been listened to or absorbed sufficiently to have the desired effect.

Recently, interactive forms of media have become prevalent, such as the Internet. Suppliers of goods and services have also tried to promote their wares through such interactive media. The primary form of Internet advertising, referred to as banner advertising, has been somewhat of a failure. Banner advertising generally takes the form of a small banner that promotes a specific vendible product. When the banner advertisement is clicked on, the user is then taken to the advertisers site, where more detailed information is provided about the products or services. In essence, the banner advertisement competes for the viewers attention with the other material provided at the site. The hope is, that once the viewer has read or watched the content of primary interest, such as a news story or the like, then there will be sufficient attention left over for the viewer to notice and to follow the lead of any banner advertising. However, this is not effective in practice.

In addition to keeping track of who logged onto the site, the interactive nature of the Internet permits the banner advertiser to deposit a cookie onto the user's computer, which keeps track of the other sites visited by the user. In this way the advertiser can begin to develop a profile of what that viewer might be most interested in, and thus, what specific target market the viewer falls into.

Unfortunately, such banner advertisements have proven to be unreliable as a means of attracting consumers' attention. More specifically, there does not appear to be a sufficient enough correlation between the numbers of hits on a banner advertisement (which at first was thought to be analogous to the reach of traditional advertising media) and any increase in sales of the promoted wares or services. Thus, recently there has been much upheaval in the equity markets relating to the so called dot.coms as the revenue supposedly derived from such banner advertising, needed by such companies to pay for the expense of developing and maintaining their sites, has all but dried up.

Advertising is only one form of specific information that may be provided to viewers via the Internet. There are many other types of specific information that can be provided, for example, remote learning, health and safety information and the like. What is needed is a better way to reach specific audiences with information of specific relevance to them and to be able to monitor whether the specific information provided to the target audience has been actually received and understood. In other cases it would be useful to know what the reaction of the target audience is to the specific information.

### SUMMARY OF THE INVENTION

An object of the present invention is to provide to a target audience comprised of individual Users content that is sufficiently interesting to cause the target audience to want to participate in the receipt of specific information. In this way the desire to participate can be used as an inducement to cause the target audience to be more receptive to the specific information being communicated which they might otherwise choose to ignore or worse, to avoid. Further, according to the present invention, the content can be compelling enough to encourage the target audience to not only be receptive to the specific information but also to absorb and retain some or all of the specific information that is provided. Further, the present invention provides a means to selectively evaluate how well the specific information provided to the target audience has been received and absorbed. In this way, confirmation that the specific information needed to be communicated has, in fact, been communicated can be obtained. Further the present invention provides incentives to the Users to volunteer personal information to permit the specific information to be provided to be as relevant as possible to the needs or wants of the specific User, without the need to track the User's activities over time to try to infer such interests.

Therefore, according to a first aspect of the present invention there is provided a method of interfacing with one or more users over an interactive medium, said method comprising the steps of:

providing access to content of sufficient interest to said one or more users to encourage said one or more users to be receptive to specific information;

providing said specific information to said one or more users over said interactive medium as a first precondition to permitting said one or more users to have access to said content;

requiring a specific response relating to said specific information from said one or more users as a second precondition to access to said content; and

upon said one or more users meeting said first and second preconditions, permitting said one or more users to access said content.

According to a further aspect of the present invention there is provided a method of communicating with one or more users over an interactive medium including the steps of:

seeking a specific response from a user and rewarding said user for said response;

providing access to said user to a game, wherein said reward can be used in said game; and

permitting said user to accumulate additional rewards through said game.

According to a further aspect of the present invention there is provided a method of inducing users to participate in an interactive site, said method comprising the steps of:

a) offering said users an opportunity to participate in a game;

b) requiring said users to participate in an information exchanging activity as a precondition to participating in said game;

c) providing said users with one or more credits for participating in said interactive site; and

d) providing to said users an opportunity to win additional credits in said game.

### BRIEF DESCRIPTION OF THE DRAWINGS

Reference will now be made to various figures that depict, by way of example only, preferred embodiments of the invention and in which:

FIG. 1 shows a preferred form of main menu page according to the present invention;

FIG. 2 shows a sample screen displaying one form of specific information that can be provided according to the present invention;

FIG. 3 shows a typical screen showing a User response screen to the specific information according to the present invention;

FIG. 4 shows a sample pre-game level selection screen accessible after an appropriate user interaction to the user response screen according to the present invention; and

FIG. 5 shows a sample screen depicting a two User game in progress at a pre-selected level according to the present invention.

### DETAILED DESCRIPTION OF THE PREFERRED EMBODIMENTS

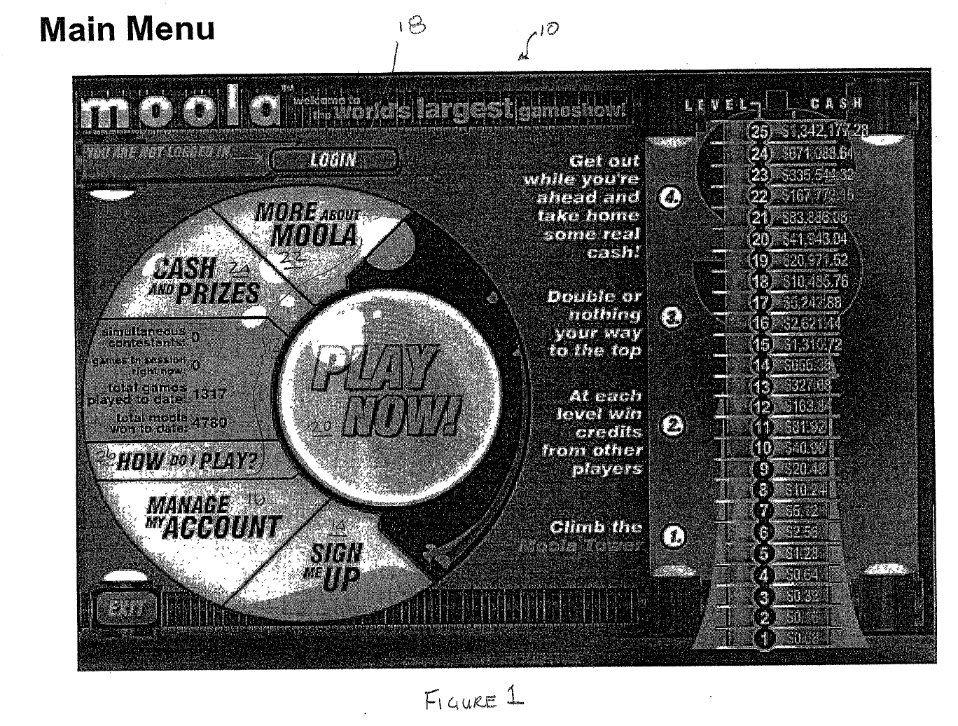

FIG. 1 shows a depiction of a typical main menu page according to the present invention. As will be understood by those skilled in the art that this form of main menu is provided as an example only and there are many forms of main menu pages that could be used to implement the present invention. However, satisfactory results have been achieved with a main menu page as depicted. Further, while the teachings which follow are in the context of the interactive medium of the Internet, the present invention is not restricted to the Internet and other interactive media are also comprehended by the present invention.

In the following description the term Host is used to describe the entity offering the methods according to the present invention. The term User is used to describe an entity participating in the methods offered by the Host. In this description, target market or audience means those individual Users to whom any specific information is directed. Specific information in this context means information to be communicated to the User through the Host. Credit means a reward used as an encouragement for Users, and comprehends all forms of benefits. In the most preferred form credits are exchangeable for real value items, such as money, in the event sufficient credits are obtained. However, the term credit comprehends all different sorts of rewards and incentives.

It will be understood by those skilled in the art that there are a number of steps that are usefully performed prior to the User having access to the main menu page of an interactive site. For completeness they will be now described. First, the User will type in the web address of the site in their browser. At present the site address is www.Moola.ca. but it could, of course, be any suitable web address. By typing in the web address, the User's browser request is routed to the Host's web server. The web server may respond for example by issuing a Flash animated splash screen that is then displayed on the User's computer through the User's web browser.

Then it is preferable to undergo a series of compatibility tests to ensure that the User's computer system possesses the necessary hardware and software capabilities to properly interact with the Host system. In the most current version of the present invention, these tests include testing for a recently issued browser, and software modules entitled Macromedia Flash 5 plug-in and Windows media player 6.4 or 7.0. Of course various other specific compatibility tests can be made depending upon the Host system's configuration and the foregoing test set is but one current example. In the event the compatibility tests fail, then the User is prompted to update their system to make it compatible, by for example, obtaining the necessary software upgrades. In the event the test is successful, then the User is prompted to select a preferred display format from a choice of formats. For example, one display format can use a smaller sized display on the User's screen, whereas another display format can be a full screen display.

Then the last connection issue to resolve is to choose a performance option from the Host that most closely represents the bandwidth available to the User. Optionally, the Host may test the User's bandwidth choice by downloading a file and determining the length of time the download takes. Most preferably the bandwidth test download will be a file needed by the User to progress to the next step anyways, such as a Flash file with the main menu. Choosing a compatible bandwidth will ensure that any specific information downloaded to the User will be both timely and optimized for resolution. This bandwidth compatibility is not an essential part of the invention and only arises at present due to the limitations inherent in the bandwidth presently available for Internet traffic. In the future the available bandwidth might well eliminate this issue and if so this step can be eliminated.

FIG. 1 shows the main menu 10 which represents one form of the present invention. By way of example the main menu 10 presents a number of options to a User. For example, the User may select from among, a learn about connection 12, a sign up connection 14 to establish an account, a connection 16 to manage an existing account, a login connection 18 and a connection 20 which permits the User to enter a game arena. At present it is preferred to send the main menu 10 to the User's web browser in the form of Flash files, which can be stored in the User's internet cache so they do not have to be re-downloaded every time. Further, it is preferred for security of data transfer to establish a secure connection between the Host server and the User by means of, for example, an SSL layer that provides for encryption and decryption at each end. Provided that the secure exchange of data can occur, other forms of security are comprehended by the present invention.

The learn about connection 12 permits the User to browse for example through more information about the site offered by the Host. The information provided might be broken down into categories such as more information 22, cash and prizes 24, and the rules of the site 26. While not essential this information is often useful to first time Users.

The sign up connection 14 will preferably permit a new User to establish an account on the Host server for the purpose of using the site. The User, for future logins, can then access this same account. The preferred form of sign in is for the User to provide their user-name and password and then to request the formation of an account. This user-supplied information can be checked, for example by the Flash pages loaded into the browser for format compatibility and if adequate, then the information can be communicated to the Host server. As noted previously this communication is preferably in the form of encrypted data transmission. The Host server then evaluates the data to see if the information provided by the User is sufficient for opening a new account and also to check to ensure that the combination of User's name and password are unique. Thus, if the User's name and password are not available, this is communicated back to the User who is requested to select a different name and/or password. If the User's choice is acceptable, then a new account (computer file) is opened on the Host server for that User.

It will be appreciated by those skilled in the art that in many circumstances it is desirable for the Host to obtain further demographic, geographic or psychographic information about the User, such as their age, sex, occupation, interests, income, family, career and the like. Thus, the present invention comprehends using inducements to cause the User to volunteer such information. In a preferred form of the present invention the User is drawn to the Host site by a form of highly desirable content. The most preferred form of such content is a form of a game to which the User may obtain access to upon meeting certain preconditions, which are explained in more detail below. In this context the present invention comprehends using increased player status in the game as an inducement for the User to volunteer such personal information. By having the User volunteer such information two benefits are obtained. First, the information is immediately available and there is no need to use the intrusive cookie method of the prior art. Secondly, the specific information provided can be directly correlated to the User, to maximize or optimize the usefulness of the specific information.

If the User already has an account then the User may access an account management utility 16. At this utility the User can review their history of activity at the site, including any game playing, their current status, the number of credits and their demographic information. To access the account management utility the Flash first verifies that the correct username and password combination have been entered. This is accomplished at the web server by comparing the request to the stored records. If there is a match, then the Host server sends out the encrypted information to the Users web browser, where it is converted to a script form and the information displayed for the User. At this time, the User may upgrade their game status by volunteering more personal information. It will be appreciated that the exact type and amount of personal information can vary according to the nature of the communication being managed by the present invention. However regardless of the type of communication the advantage of the present invention is that the User can be induced to reveal additional information in exchange for a benefit such as an improved game status.

If the User does not wish to either create an account or to manage their account information, then the User may instead simply login to the site at 18. It will be understood by those skilled in the art that the act of setting up an account or managing an existing account will also act as a login to the site. For a straight login for a User who already has an account from before, the steps are substantially as identified above, namely, that the User provides the correct username and password combination. The Host server then verifies that the correct username and password combination have been entered. If there is a match, then the Host server sends out the encrypted information to the User's web browser, where it is decrypted and processed by the Flash running on the User's web browser. Upon a successful login the User's browser stores the login information within the Flash so that when the User encounters an area in the site where login information is again required, the Flash can automatically provide it in a field appropriate way.

Now that the description of how the User may login is complete, the present invention can now be more fully understood. The next step for the User is to click on the play game link 20. The present invention contemplates sending Users back to login, if they are not already logged in. Thus, only logged in Users are permitted to access the play game section through link 20. Upon a successful login, the Host computer creates a unique session identifier to keep track of the particular session of the User. The information in the session identifier is the primary way for the Host system to relate to that User session.

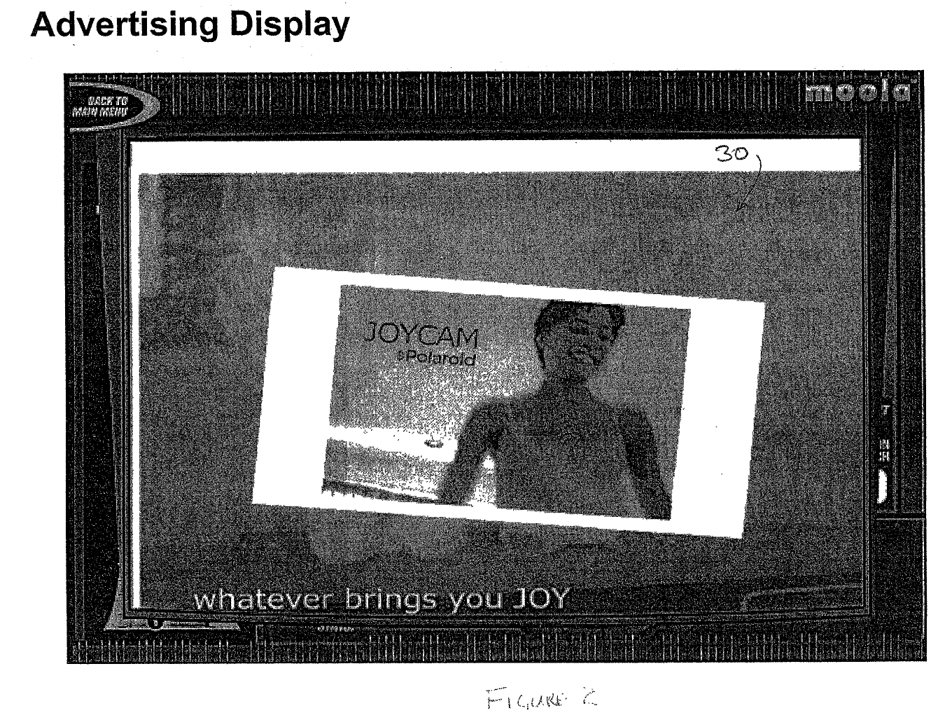

Once the session identifier is initiated then the Host sends a fresh web page to the User's web browser. A sample of such an image is shown in FIG. 2. In the example of FIG. 2 the image is in the form of an advertisement 30 for a product. However, it will be understood that the present invention comprehends broadly providing any specific information to the User as the Host wishes. Thus, for example, the image could be a set of information for remote learning or any other type of specific information. What is comprehended by the present invention is that the User participates in an information exchanging activity, such as where specific information is provided to the User in a format that permits the User to review and retain the specific information. For ease of the User, preferably the specific information is provided in a rich media, full motion video format, but other formats are also comprehended which suit the specific information provided.

The communication of the specific information according to the present invention is a prerequisite for the User to proceed to the next step. In other words, the User cannot advance to the next step without first having the presentation of the specific information or participating in the information exchange. It will be appreciated that additional specific information can be presented to the User at various stages. What is comprehended is that the User will be exposed to specific information periodically throughout the User session.

More particularly, the specific information provided to the User will be selected from a database of specific information and will be suited to the specific User based on the User's demographic, geographic or psychographic profile. For example, the Host system can review the viewer's demographic information, and the specific information previously received during the session or in previous sessions and can provide further additional specific information. Due to current bandwidth limitations it has been found desirable to pre-cache the specific information on the User's hard drive for ease of access the first time the specific information is provided to a User. However, in the future if such bandwidth constraints are removed this pre-caching step may not be necessary.

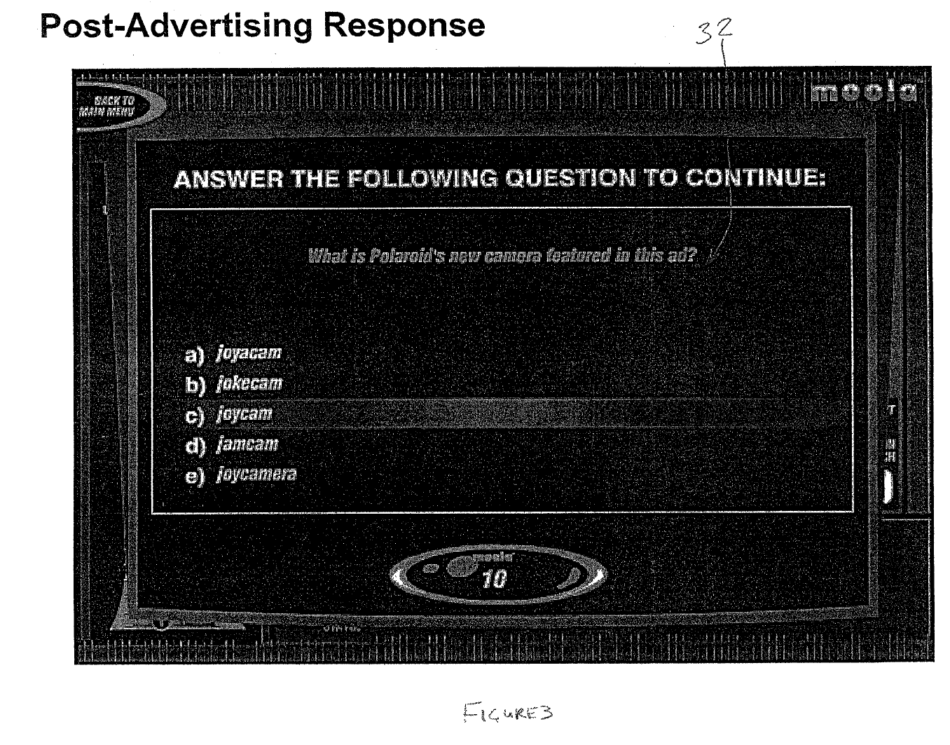

Following the specific information display segment the next step for the User is a specific information response segment. In this step there are posed to the User one or more questions relating to the specific information just provided to the User. FIG. 3 shows one type of screen that may be used. In the example of FIG. 3 there is provided a multiple-choice question 32. It will be understood that the question may relate specifically to the specific information to test the User's observational abilities and retention of certain portions of the information, or the question may relate more generally to the User's opinion of the specific information such as the effectiveness of the display, whether the User enjoyed the specific information or other information, known to the User.

The present invention comprehends that the specific information may be accessed a number of times by the User. For example, as explained below, a persistently inappropriate User response will initiate the recommunication to the User of the specific information. Additionally, multiple responses may be sought from the User in respect of the same set of specific information. As a result, storing the specific information on the Users system helps avoid bandwidth constraints.

If the question is directly related to the specific information there will be for example in a multiple choice question, one right answer (shown as (c)) and several wrong answers (shown as (a), (b), (d) and (e)). The User will be required to provide the correct answer (c) before being allowed to proceed to the next step. A credit towards playing a game in the next step is a preferred outcome of a correct answer. Good results have been obtained where the User is required submit a second response if the first one is wrong and where the order of the answers is varied in the question display format to prevent random guessing. Further in the event of two wrong answers, it is preferred to require the User to review the specific information again, before permitting a further attempt to answer the question.

To accomplish the foregoing, the User's web browser will request the specific information question via a script from a data base associated with the specific information which will then cause the question to be displayed for the User. When the User selects a specific response as a possible answer, the web browser, through the Flash program, submits the information to the Host server for verification. If the response is incorrect, an incorrect message is transmitted to the browser and displayed to the User. If the response is correct, then this is also communicated to the Flash program and the User is awarded a credit then advanced to the next step.

It will be appreciated that the question response format is only one embodiment of the present invention and that it comprehends other forms of information exchanging activities. For example, the information exchanging activity could also take the form of a survey, in which the User is requested to answer certain questions in order to earn a credit and advance to the next step.

At this point the User is on the threshold of the content that is sufficiently desirable to cause the User to participate in the foregoing specific information review and response, or information exchanging phase. In the most preferred form of the invention the content of sufficient interest is in the form of a game. Ideally the game provides the User with entertainment, through the playing of the game in real time against live competitors and the possibility of prizes. In the most preferred form of the invention, the game prizes are immediately available and directly related to the specific outcome of the game. In this manner the User is able to obtain the possibility of immediate gratification and reward for their participation in the Host site.

According to the present invention the Host site offers to the User two means to acquire credits. The first is to review the specific information and then correctly answer the question that follows. This will result in the award of a credit that is an earned credit. In this sense, the actions of the User are directly responsible for the credit arising. The second is to successfully compete in a game, most preferably a real time game against other Users. In this case, a winner can obtain credits earned by others, which are referred to as won credits. It can now be appreciated that the User will login the first time with no credits and does not contribute any monetary consideration of any sort to participate. All that is required is to participate in the information exchange to accumulate earned credits to allow the User to participate in the interactive Game portion.

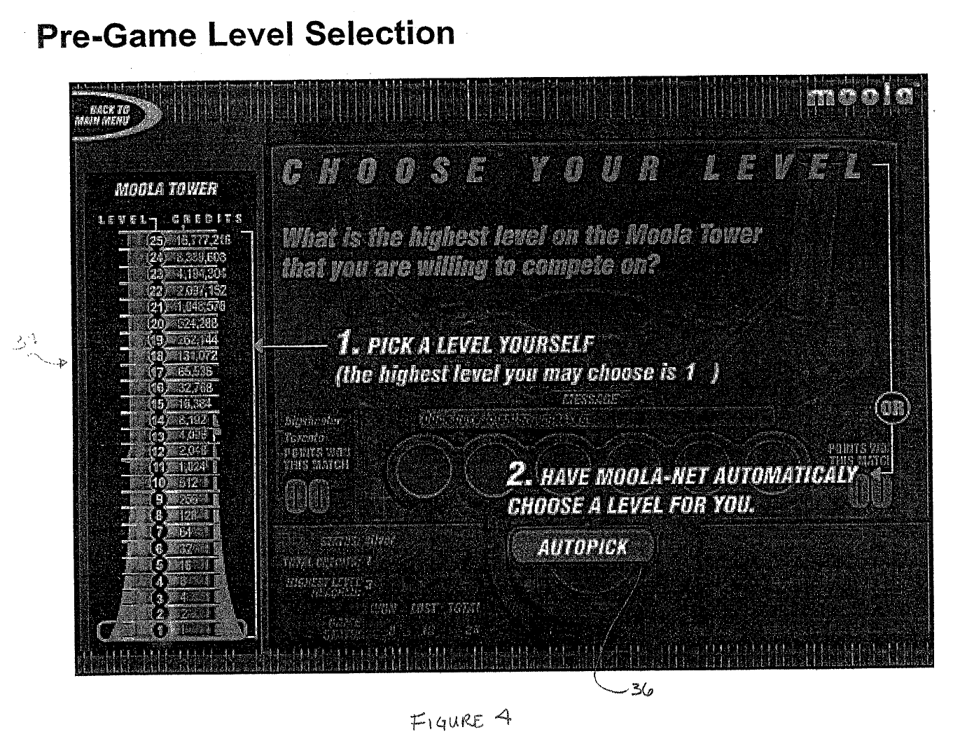

The preferred form of the game can now be understood. FIG. 4 shows a pre-playing page that allows the User to make certain selections relating to the playing of the game itself. According to one aspect of the invention the User is permitted to select which level 34 they wish to play at, according to the total number of credits the User has. Thus, in FIG. 4 the User must stipulate a level to play by clicking on that level shown on the screen. After selecting a level the User is inserted into a cue for that level. Other Users may already be in the cue, in which case a match is made and a game is commenced. If there are no other players in that cue, then the User may wait until such a player is available. To avoid excessive delays it is preferred to provide to the User the option of an autopick 36, which will allow the Host computer to immediately pick the first available player at a level up to and including the level the User selected.

Once a match of Users is obtained, then a message is flashed to each of the Users indicating that a match has been found. At this point each of the matched Users may be given the option of accepting or declining the match. If both players accept then a game is commenced. It will now be understood that the various levels of the game are determined by how many total credits the User is willing to risk in interactive competition. Thus, to risk more total credits the User must have more total credits in the first place.

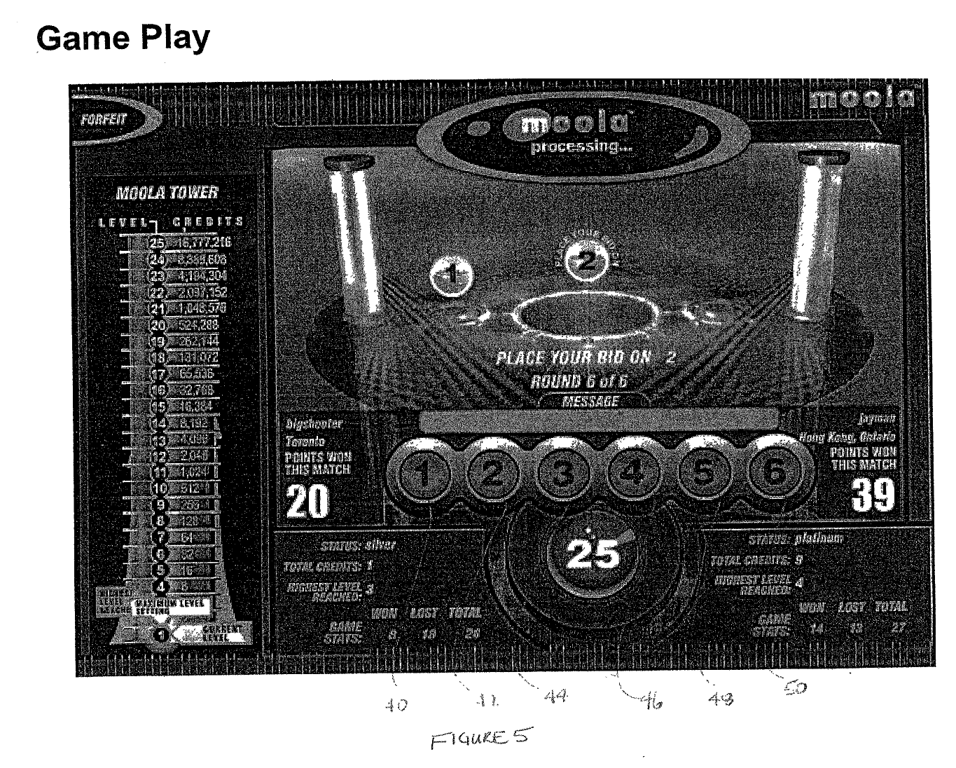

FIG. 5 shows a screen that presents one form of a two player competitive game. In this form of the game, each player is given six marbles 40, 42, 44, 46, 48 and 50, having a value from 1 to 6 respectively. Each User selects one marble at a time to play. Neither User knows which marble value the opposing User has selected until after both Users have made their selection. After both selections have been made their respective values are compared. The higher valued marble played by either User wins and the points from both played marbles are awarded to the winning User. All six marbles are played one at a time by each User and after the last marble has been played the total points for each User are tabulated and compared. The present invention further contemplates that additional points be made available, to the winner of any given round in the game. Such additional points may be randomly valued, for example, at one to six points, and the Users bid against each other for these points also. The score therefore includes the sum of the winner's marble, the loser's marble and the random point total. The User with the higher point total wins and as a result of winning receives all of the credits appropriate to that level of the game, which are won credits. The other Users, the losers, also lose these credits.

The overall context of the present invention can now be understood. The present invention provides content of sufficient interest to a target audience to encourage the individual members of the target audience to participate and to be receptive to specific information to be conveyed to them. Further the User can be encouraged by means of inducements to provide demographic and other information about themselves to permit the specific information provided to the Users to be more precisely correlated to the specific attributes of that User. In the context of advertising, for example, if a User identifies that their car is over a certain age, the specific information provided could be about new vehicles currently available. The inducement to encourage the User to provide such information can take the form of enhanced game playing status, for example, by allowing the User to accumulate more credits per correct answer in response to the viewing of the specific information provided.

It will be noted that the present invention permits Users to participate merely by logging on and identifying themselves. No credits are purchased nor is there otherwise any entry fee associated with the login procedure. Thus no valuable consideration in any form is required to enter the site or to participate in the methods of the present invention. In this way the present invention is directly accessible by anyone who has access to the interactive medium, such as the Internet. In one embodiment each User is required to view the specific information and to answer a verification question confirming, for example, that they viewed the content. This acts as a precondition to the User participating in the content of interest, namely, the game. In another embodiment the User may simply be required to answer certain questions, in the nature of a marketing survey or the like.

Another important aspect of the present invention is the ability to win credits through the game playing, in addition to being able to earn credits. Essentially the ability of the winner to win credits earned by the loser in the game allows the total credits to be more rapidly accumulated in the game than through earning them. The rate of accumulation of credits to a winning User for a two person game is essentially exponential. The credits have no monetary value but may, according to the present invention, be exchanged for prizes or even cash if a significant enough number of credits can be accumulated.

In the context of attracting Users to the game, the ability to accumulate significant credits over a short time is important. Typical ad rates for Internet banner advertising are very small, as low as one or two pennies per ad per viewer. Thus, to accumulate significant cash prizes in the game, which cash prizes are a large part of the attraction of the game portion for the Users, the present invention provides a more rapid way to accumulate credits than by merely being receptive to specific information. Thus, while an advertiser, for example, is willing to pay one or two cents for each User who views the advertisement, if a large number of Users have viewed the ads, the number of credits in total in all the Users accounts will grow, and through the successive levels of the game will tend to be accumulated in fewer and fewer User accounts. These will of course be the accounts of the winners. In essence this means that certain individual Users will through the game itself accumulate enough credits for example to cash out at a significant amount of money. By way of example, in a preferred form of the present invention with a two User game format, a winner of ten games (in a row) will accumulate enough credits to be able, if they so choose, to cash out at about fifty dollars, a winner of twenty games in a row will be able to cash out at about ten thousand dollars and a winner of twenty five games in a row will be able to cash out at over one million dollars. If each game played between Users includes a game format for more than two Users, then credits would be accumulated even more quickly. This prize money will be derived from the entity who has placed the specific information on the Host site, and may, for example be advertisers who have placed specific information in the form of advertisements.

Thus, while it would take a significant amount of time to accumulate enough earned credits through review and retention of the specific information to make it worth doing, the rate of acquisition of won credits through game playing is fast enough to be very interesting to Users. Thus, it is possible for example to have a User achieve enough won credits in a relatively short time to be able to win and cash in for significant sums of money. In the most preferred form of the present invention the User may cash out at any time. Thus the present invention provides a unique and appealing opportunity to accumulate significant prize value making the game playing aspect, or the content, highly desirable, to a wide range of Users.

It will further be appreciated by those skilled in the art that although one form of game has been described there are many forms of game that could also work. The essential elements of the game are considered to be that the credits earned by others accumulate to the winner after a round of the game. Also in the game described there is a certain element of luck, which is believed to make the game more appealing because the outcome is not a simple test of skill or intelligence. Thus, even a lower skilled player has a chance of winning over a more skilled player. Since by definition there will be many more losers than winners, the element of luck according to the present invention keeps the Users returning, after losing.

It will also be appreciated that the loser of any round of the game will lose from their account the total amount of credits at issue in that level of the game. If there are no more credits left in their account then they must again review the specific information and to earn further credits. In a further aspect of the present invention even the winners can be required to return to the specific information viewing stage before being allowed to proceed to the next level of the game. Further to prevent the accumulation of credits solely through earning credits, the present invention contemplates restricting awarding credits to Users having null credit accounts (i.e. game losers). Winners may still be required to participate in an information exchange between rounds, but will not necessarily be provided with additional credits for doing so.

Although reference has been made in the foregoing description to an interactive game to played between two Users, the present invention further comprehends that more than two Users could be engaged in a game at the same time. This would allow an even more rapid accumulation of won credits to a winner.

It will be appreciated by those skilled in the art that various modifications and alterations can be made to the foregoing description without departing from the broad scope of the appended claims. Some of these variations have been discussed above and others will be apparent to those skilled in the art. For example while the foregoing description includes certain software references and design features intended to deal with various technical limitations such as restricted bandwidth it will be understood that other system configurations could also be used if no such restrictions are present. Further while the examples provided relate to the providing of advertisements, such as television style advertisements, the specific information can be any form of information that needs to be provided to a user in a controlled and monitored way. For example the present invention also comprehends that the specific information provided could be used as a remote learning tool for all ages and subjects and the response to the questions about the specific information would provide an indication of how the student User was learning.

The embodiments of the invention in which an exclusive property of privilege is claimed are defined as follows:

1. A method of interfacing with one or more users over an interactive medium, said method comprising the steps of:
providing access to content of sufficient interest to said users to encourage said users to be receptive to specific information;
providing said specific information to said users over said interactive medium as a first precondition to permitting said users to have access to said content;
requiring a specific response from said Users relating to said specific information as a second precondition to access to said content; and
upon said users meeting said first and second preconditions, permitting said users to access said content.

2. A method of providing information to one or more users over an interactive medium as claimed in claim 1 wherein said content comprises a game and said method further includes the step of said users receiving a credit to permit said users to commence playing said game, upon said users completing said second precondition.

3. A method of providing information to one or more users over an interactive medium as claimed in claim 1 wherein said content is a game and said method further includes the step of allowing said users to advance to a next level in said game upon said users completing said second condition.

4. A method of providing information to one or more users over an interactive medium as claimed in claims 2 or 3 wherein said game is an interactive game between at least two users, and said method further includes the step of awarding to a winner of said game one or more credits.

5. A method of providing information as claimed in claim 4 wherein said one or more credits awarded to said winner were not received by said winner, but received by said one or more losers.

6. A method of providing information as claimed in claim 4 wherein said credits which are won may be accumulated much more quickly than said credits otherwise received.

7. A method of providing information to one or more users over an interactive medium as claimed in claim 1 further including the step of inducing said one or more users to volunteer personal information.

8. A method of providing information to one or more users over an interactive medium as claimed in claim 7 wherein said one or more users wherein said step of inducing said users to volunteer personal information includes the step of providing said one or more users with one or more of an enhanced game playing status or an enhanced credit redemption status.

9. A method of providing information to one or more users over an interactive medium as claimed in claim 1 wherein said step of requiring a specific response includes a step of comparing a given user response to a predetermined response.

10. A method of providing information to one or more users over an interactive medium as claimed in claim 9 further including the step of requiring a second response in the event the first response does not match the predetermined response.

11. A method of providing information to one or more users over an interactive medium as claimed in claim 9 further including the step of re-providing the specific information to the users in the event the response does not match the predetermined response.

12. A method of providing information to one or more users over an interactive medium as claimed in claim 11 including the step of providing user accounts to keep track of said credits.

13. A method of providing information to one or more users over an interactive medium as claimed in claim 12 further including the step of permitting said one or more users to manage their individual accounts.

14. A method of providing information to one or more users over an interactive medium as claimed in claim 13 further including the step of using a session tracker to keep track of a user's progress.

15. A method of providing information to one or more users over an interactive medium as claimed in claim 2 wherein said game includes a plurality of levels and said method includes the step of permitting said users to only play at any level appropriate for the number of credits possessed by said user.

16. A method of providing information to one or more users over an interactive medium as claimed in claim 2 wherein said game includes a selection of individual elements having a unique value, and each competing user is required to select said individual elements one at a time.

17. A method of communicating with one or more users over an interactive medium including the steps of:
seeking a specific response from a user and rewarding said user for said response said reward taking the form of an earned credit;
providing access to said user to a game, wherein said earned credit can be used in said game to win additional credits; and
permitting said user to participate in a game to potentially win additional credits.

18. A method of communicating with one or more users over an interactive medium as claimed in claim 17 wherein said step of permitting said user to participate in said game includes allowing said user to compete against one or more other users for additional credits.

19. A method as claimed in claim 18 wherein a user may acquire said won credits much more rapidly than said earned credits.

20. A method of communicating with one or more users over an interactive medium as claimed in claim 18 wherein said step of competing against one or more other users occurs in real time.

21. A method as claimed in claim 17 further including the step of providing specific information to said user prior to seeking a specific response.

22. A method of communicating with one or more users over an interactive medium as claimed in claim 20 further including the step of inducing said users to provide personal information by enhancing said users game playing status or credit redemption value in exchange for said information.

23. A method of inducing users to participate in an interactive site, said method comprising the steps of:
a) offering said users an opportunity to participate in a game;
b) requiring said users to participate in an information exchanging activity as a precondition to participating in said game;
c) providing said users with one or more credits for participating in said interactive site; and
d) providing to said users an opportunity to win additional credits in said game.
